(19) United States
(12) Patent Application Publication
(10) Pub. No.: US 2003/0070344 A1
(43) Pub. Date: Apr. 17, 2003

(54) Fishing line wobble device

(76) Inventor: Dean M. Teegarden, Boise, ID (US)

Correspondence Address: DYKAS, SHAVER & NIPPER, LLP, P O BOX 877, BOISE, ID, 83701-0877, US

(21) Appl. No.: 10/300,051

(22) Filed: Nov. 18, 2002

Related U.S. Application Data
(63) Continuation-in-part of application No. 09/771,213, filed on Jan. 25, 2001.

(51) Int. Cl. A01K 85/00

(52) U.S. Cl. 43/42.1

(57) ABSTRACT

A fishing line wobble device for creating a wobbling effect in drawn fishing tackle. The wobble device has a deflector for deflecting water and a tubular line guide for allowing the device to freely slide along the fishing line. The wobble device imparts a life-like wiggling motion to natural and artificial fishing baits and lures, including flies, real and plastic worms, rubber baits, and other lures. The wobble device also helps keep weeds and other obstructions from snagging the hook of the fishing tackle. The wobble device is used by merely sliding it onto the fishing line before the fishing tackle or hook is tied on the line or otherwise attached.

### PRIORITY

This application is a continuation-in-part of U.S. patent application Ser. No. 09/771,213, filed on Jan. 25, 2001, the disclosure of which is incorporated by reference.

### DESCRIPTION

### BACKGROUND OF THE INVENTION

1. Field of the Invention

The present invention generally relates to fishing lures, and more particularly to a fishing lure accessories used to make a fishing line wobble as it is drawn through the water, thereby imparting movement to a fishing lure attached to the fishing line.

2. Background Information

As a fishing lure is drawn through the water, it is often advantageous to the fisherman to have the lure mimic the natural swimming patterns or behaviors of a juvenile fish or other food source of the fish to be caught. Typically, this wobbling effect is created through the use of a water deflection device. These water deflection devices range from spoons to baffles (Rhoten, U.S. Pat. No. 5,887,378) to spinners (Baker, Jr., U.S. Pat. No. 4,891,901).

A typical spoon is rotatably attached at one end to the fishing tackle. Then as the tackle drawn through the water, the spoon deflects water and is able to revolve around the axis defined by the fishing line via a pivoting attachment. A spoon imparts a wobbling motion to the lure as well as creating a visual display (or pressure disturbance in the water) which attracts the attention of fish.

A typical baffle operates by deflecting water (thereby deflecting the lure itself), with the deflection of the lure causing the desired effect (wobbling). An example of a baffle is shown in U.S. Pat. No. 2,713,742 (Holdaway). Holdaway's fishing hook baffle snaps onto the shaft of a hook. Another example is U.S. Pat. No. 5,918,406 (Wilson). Wilson's wiggling fishing lure utilizes a dual segmented, generally L-shaped baffle having the lure attaching to the end of one segment and the line attaching to the center of the second segment. Another baffle is shown in U.S. Pat. No. 2,795,075 (Christian). Christian's fishing lure utilizes a bow-shaped baffle able to pivot at the center of the bow.

A typical spinner operates by spinning through the water as the lure is drawn. Spinners tend to do two things: (1) cause the lure to spin, or (2) creates a visual display (or pressure disturbance in the water) which attracts the attention of fish.

Additionally, known is also the use of diving plates or planes for causing a lure to dive as drawn through the water, thereby allowing the lure to be used at deeper depths without resulting to using sinkers or weights to sink the lure. Examples of diving planes can be seen on Davis (U.S. Pat. No. 4,739,576), Francklyn (U.S. Pat. No. 4,869,014), and Even (U.S. Pat. No. 6,016,622).

What is missing in the prior art is a wobbling device which can easily be added the fishing line in-line in front of existing fishing tackle without any modification of the tackle itself. This way, the fisherman is able to add wobbling functionality to his/her existing lures and other tackle without modifying the existing tackle. It is a further object of the present invention to provide a fishing line wobbling device of unitary construction, allowing for quick and easy manufacture, assembly and use. The present invention solves these needs.

### SUMMARY OF THE INVENTION

The present invention is a fishing line wobble device for causing fishing line drawn through water to wobble, thereby imparting motion to fishing tackle attached the fishing line. Generally, attachment to the fishing line is achieved by simply sliding the device onto the fishing line before the bait or lure is tied on or otherwise secured.

The preferred embodiment of the fishing line wobble device comprises a deflector for deflecting water and a line guide for allowing the device to slidably engage the fishing line. It is preferred that the deflector be cup-shaped, having an apex designating a rear side opposite a rim designating a front side. This rear side is oriented towards the fishing lure attached to the line. The deflector also having a line guide, this line guide preferably tubular and generally straight. The line guide preferably extends through the deflector, generally perpendicular to the rim, and extends away from the rear side of the deflector. The invented wobble device imparts a life-like wiggling motion to the fishing line. This line movement results in a life-like movement of natural and artificial fishing baits and lures including flies, worms, rubber baits, etc. which are attached to the line. The invented wobble device also helps keep weeds and other obstructions from snagging the hook of the tackle.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a side view of one embodiment of the present invention.

FIG. 2 is a front view of the embodiment of FIG. 1.

FIG. 3 is a back view of the embodiment of FIG. 1

FIG. 4 is a perspective view of the embodiment of FIG. 1.

FIG. 5 is a partial, cross sectional environmental view of a second embodiment of the present invention.

FIG. 6 is a partial, sectional environmental view of the embodiment of FIG. 5.

FIG. 7 is an environmental view of the embodiment of FIG. 5.

FIG. 8 is an environmental view of another embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

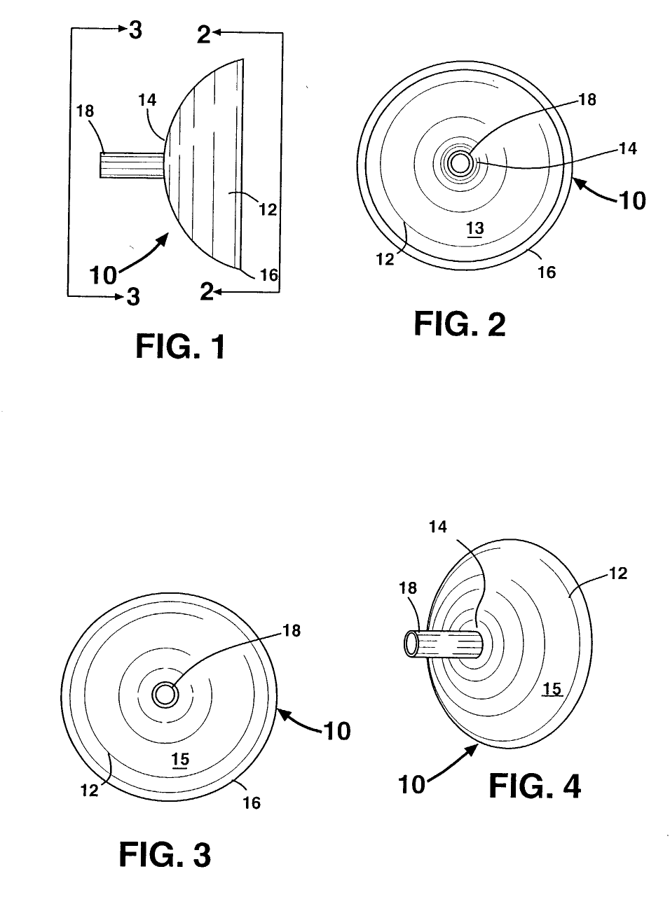

Initially referring to FIG. 1, a first embodiment of the present invention is shown. This embodiment shows the fishing line wobble device 10 comprising a deflector 12 and a line guide 18. The deflector 12 is generally cup-shaped, having an apex 14 and a rim 16. In this embodiment, at or near the apex 14, the line guide 18 extends through the deflector 12. It is preferred that the length of the line guide 18 be generally perpendicular to the rim 16. In the preferred use, the rim 16 end of the wobble device 10 would be oriented on the fishing line generally facing the fishing pole, and the line guide 18 end of the wobble device 10 would be oriented on the fishing line generally facing the fishing hook or lure.

Referring now to FIG. 2, a front view of the embodiment of FIG. 1 is shown. In this view, one can see that the deflector 12 has a front side 13 (which is opposite the back side 15 show in FIGS. 3 and 4). While the deflector 12 in this embodiment is generally circular cup-shaped, having a convex back side 15 (FIG. 3) and a concave front side (FIG. 2), other shapes of cup-shaped deflectors are envisioned, for example (but not limited to): disc shapes, elliptical cup shapes, figure-8 outline shaped, etc.

The cup-shaped deflector 12 of FIG. 2 shows a rim 16. Preferably at or near the apex 14 of the deflector 12 will be located the line guide 18. In such a manner, the line guide is preferably centered within the deflector 12. The benefit of using a circular cup-shaped deflector is that the deflector itself has no up or down. Thus if the deflector rotates during use, the performance of the device 10 itself is not compromised. FIG. 2 shows the line guide 18 extending into the cup of the deflector 12. While this is preferred, it is also possible for the deflector end of the line guide to be flush with the front side 13.

Referring now to FIG. 3, a back view of the embodiment of FIG. 1 is shown. This view shows the deflector 12 having an apex 14 and a rim 16, a back side 15 and a line guide 18. As shown in this view, this embodiment of the present invention has a line guide 18 which is generally cylindrically tubular in shape. However, other shapes would be also possible, including but not limited to elliptical tubes, triangular tubes, rectangular tubes, etc., all of which are deemed included in this disclosure.

Referring now to FIG. 4 a perspective view of the embodiment of FIG. 1 is shown. In this view, the fishing line wobble device 10 can be seen to have a deflector 12 with a line guide 18 extending generally from the portion of the deflector 12 containing the apex 14. The deflector 12 has a back side 15. In this embodiment, the line guide 18 is generally tubular in shape and again attaches to the deflector 12 at or near the apex 14 of the deflector.

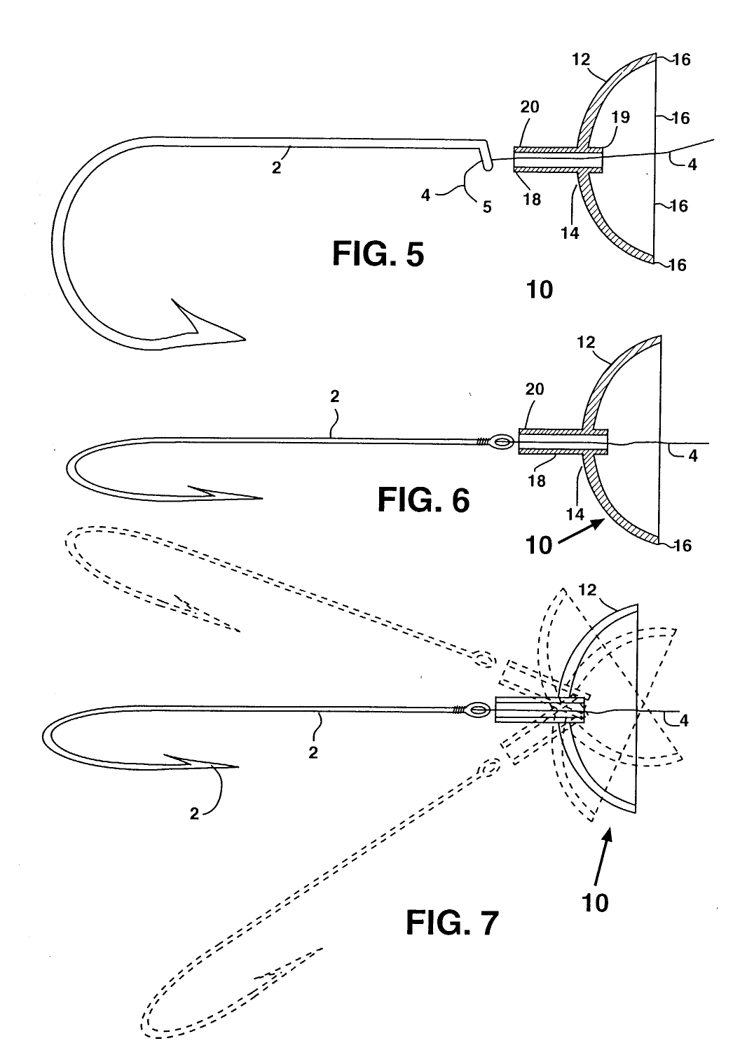

Referring now to FIG. 5, a perspective, cross-sectional view of a second embodiment of the present invention is shown. In this embodiment, the wobble device 10 has a deflector 12 which attaches to a line guide 18. This line guide has a first end 19 extending to a second end 20. The line guide 18 extends through the deflector 12 so that the first end 19 is inside the cup of the deflector 12 and the second end 20 is oriented away from the deflector. It would also be possible for the first end 19 to be flush with the inside surface of the deflector 12 or even slightly recessed. The line guide 18 is oriented and attached generally perpendicular to the apex 14 of the deflector. Such an orientation also results in the line guide 18 being generally perpendicular to the rim 16. While such a perpendicular convergence is preferred, it is also envisioned that the line guide 18 attach to the deflector 12 at other angles.

FIG. 5 also shows the correct orientation in use of this embodiment of the present invention. Shown is a fishing line 4 extending into the cup of the deflector 12, in the first end 19 of the line guide 18, through the line guide 18, and out of the second end 20 of the line guide 18. This fishing line 4 would be then used to tie on a fishing lure/tackle (FIG. 6), such as the fishing hook 2 shown. In such an orientation, when the line 4 is pulled through the water, the cup of the deflector 12 will deflect water and wobble, causing the attached line guide 18 to wobble against (repeatedly contact) the fishing line 4, imparting energy to the line 4 itself, this line energy or vibration causing the attached fishing hook or lure 2 to itself to move or wobble through the water.

Thus, the line guide 18 acts as a lever against the fishing line 4, applying energy from the water resulting from the deflection of the deflector, this energy being applied to the fishing line 4 as a vibration or movement, thereby resulting in the imparting of movement to the attached fishing lure or hook.

In the preferred embodiment, the present invention 10 does not contact the fishing lure itself, but instead contacts the fishing line, or perhaps a knot in the line, for instance the knot adjacent the leader. Thus, it is intended that the present invention transmit energy to the fishing line which itself causes motion in the lure.

Referring now to FIG. 7, the embodiment of FIG. 5 is shown in use. As the fishing line 4 attached to the fishing hook 2 is drawn through the water, the deflector 12 deflects water, thereby causing the line guide 18 to vibrate against the fishing line 4 extending through the line guide, thereby causing the fishing line to wobble, and thus causing the fishing lure or hook to wobble or move erratically.

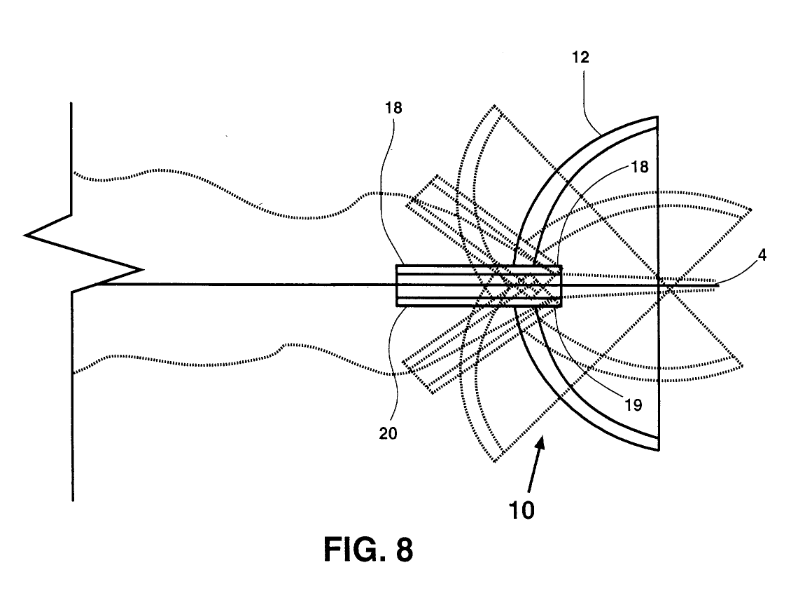

Referring now to FIG. 8, shown is another embodiment of the present invention. The slightest movement of the deflector 12 is translated into a much greater movement of the second (distal) end 20 of the line guide 18. In such a manner, the line guide 18 works as a lever. This movement of the second end of the line guide results in movement of the fishing line and ultimately results in some movement of the attached hook or lure. In such a manner, the line guide 18 bends the fishing line back and forth, thereby creating movement in the attached lure.

The preferred material for making the present invention is clear plastic, however other materials (composites, metals, natural materials, etc.) and colors are also envisioned and deemed included in this disclosure. Various external finishes (colors, etc.) are also envisioned, as is the inclusion of material within the plastic (i.e., glitter).

While there is shown and described the present preferred embodiment of the invention, it is to be distinctly understood that this invention is not limited thereto but may be variously embodied to practice within the scope of the following claims.

I claim:

1. A fishing line wobble device for causing fishing tackle attached to a fishing line to wobble as said fishing tackle is pulled through water, said fishing line wobble device comprising a deflector for deflecting water and an elongated line guide, said line guide having first and second ends for slidably engaging said fishing line, said line guide extending through said deflector, said line guide fixedly attached to said deflector, wherein said fishing line wobble device is pulled through said water said deflector is configured to be deflected by said water, thereby causing said line guide to vibrate against said fishing line and thus causing said attached fishing tackle to wobble.

2. The fishing line wobble device of claim 1 wherein said deflector has a generally concave front side, and a generally convex back side.

3. The fishing line wobble device of claim 1 wherein said deflector is generally circular cup-shaped.

4. The fishing line wobble device of claim 1 wherein said line guide is generally tubular.

5. The fishing line wobble device of claim 1 wherein said line guide and said deflector are formed of a molded plastic.

6. The fishing line wobble device of claim 1, wherein said deflector is generally cup-shaped deflector having an apex opposite a rim, and wherein said line guide is generally tubular and extends through said deflector generally at said apex, said line guide extending through said deflector generally perpendicular to said rim

7. The fishing line wobble device of claim 1, wherein said fishing tackle is a hook.

8. The fishing line wobble device of claim 1, wherein said fishing tackle is an artificial lure.

9. A fishing line wobble device for causing a fishing hook attached to a fishing line to wobble as said fishing hook is pulled through water, said fishing line wobble device comprising: a generally cup-shaped deflector, said cup-shape having an apex opposite a rim; and a generally tubular line guide extending through said deflector generally at said apex, said line guide extending through said deflector generally perpendicular to said rim, said line guide able to slide along said fishing line.

10. The fishing line wobble device of claim 9 wherein said deflector has a generally concave front side, and a convex back side.

11. The fishing line wobble device of claim 9 wherein said line guide and said deflector are formed of a molded plastic.

12. A fishing line wobble device for causing fishing line to wobble as said fishing line is pulled through water, said fishing line wobble device comprising a deflector for deflecting said water and an elongated line guide, said line guide having first and second ends for slidably engaging said fishing line, said fishing line extending to an attached piece of fishing tackle, said line guide further extending through said deflector, said line guide fixedly attached to said deflector, wherein said fishing line wobble device is pulled through said water said deflector deflects water and thereby causes said fishing line to wobble.
